(19) United States
(12) Patent Application Publication
(10) Pub. No.: US 2017/0184255 A1
(43) Pub. Date: Jun. 29, 2017

(54) LED LAMPS WITH IMPROVED LIGHT PATTERN

(71) Applicant: Tien Yang Wang, Lexington, MA (US)

(72) Inventor: Tien Yang Wang, Lexington, MA (US)

(21) Appl. No.: 14/981,810

(22) Filed: Dec. 28, 2015

(51) Int. Cl. F21K 9/66; F21K 9/232; F21K 9/235

(52) U.S. Cl. CPC F21K 9/66; F21K 9/235; F21K 9/232; F21Y 2115/10

(57) ABSTRACT

An LED lamp is disclosed comprising an envelope coupled to a lamp base. The lamp base comprises an LED module, a driver circuitry, housing, and a socket cap. The envelope comprises one or more alternating grooves and ridges forming a corrugated sidewall. A portion of light emission from the LED may be intercepted by corrugated sidewalls and extracted out before exiting the top of envelope. The spatial light pattern may become more uniform using present LED lamps. In present LED lamps, the envelope may be flexible. The shape of envelope may be adjusted by folding or bending of corrugated sidewall. The light pattern of present LED lamps may be further tuned by folding or bending of the envelope in a desirable fashion. The present LED lamp may be manufactured using conventional methods and the cost may be further reduced.

### BACKGROUND OF THE INVENTION

The present invention relates in general to LED lamps using semiconductor light emitting device (LED) as main light sources. In particular, the present invention relates to LED lamps with an improved spatial light pattern.

In a conventional LED lamp, the light pattern may be very different from that of an incandescent lamp due to directional light emission from the light emitting diode. For general lighting applications, it is desirable to reduce the spatial brightness contrast of LED lamp. By converting some of the up-emitting light to emit sideways, the uniformity of spatial distribution of light intensity can be improved. Different methods have been attempted to improve the light pattern, for example, by employing an internal reflector, a waveguide, a conic lens, an upstanding LED panel, an LED stripe, or an LED filament. However, these prior methods require either a sophisticated optical design, or a complicated fabrication process. These drawbacks translate into an increased cost of manufacturing of the prior art LED lamps.

### SUMMARY OF THE INVENTION

The present LED lamp can overcome aforementioned deficiencies. The present invention may include one or more of the following advantages. One objective of the present invention relates in general to improving light pattern of LED lamp. In specific, it relates to reducing spatial brightness contrast of LED lamp due to directional light emission of an LED light source. Another objective of the present invention relates in general to beam shaping of LED lamps. The beam shaping may be realized by using an envelope comprising a corrugated sidewall in present LED lamps. A further objective of the present invention relates in general to an LED lamp with an improved light pattern that may be manufactured in a cost-effective process. The present LED lamp is suitable in applications including, for example, general lighting.

In one general aspect, the present invention relates to an LED lamp comprising an envelope coupled to a lamp base, which comprises an LED module, a driver circuitry, a housing, a socket cap. The LED module comprises one or more LEDs. The LEDs are substantially contained in an inner space substantially defined by the envelope and lamp base. The envelope may comprise a corrugated sidewall formed of alternating grooves and ridges. The grooves and ridges may comprise an upper face and a lower face. The grooves and ridges may be substantially oriented in a plane generally transverse to main axis of the envelope. The envelope may be substantially tubular. Preferably the envelope is substantially translucent. The LEDs may be mounted on a printed circuit board (PCB). The envelope may comprise a translucent material that enables transmitting and diffusing of light. For example, it may be a translucent plastic material such as polyester, polyethylene, polypropylene, silicone, nylon, or a plastic material filled with a light diffuser. The envelope may also comprise a plastic material filled with a light conversion material that absorbs a portion of LED emission and emits a light having a dominant peak wavelength different from that of the LED emission.

In present LED lamps, a portion of light emission from LED light source may be intercepted by corrugated portion and exits envelope before reaching to the top. The geometry of corrugated sidewall may be further optimized so that more light may be redirected and extracted out by corrugated portion of envelope. For example, the relative size of envelope to lamp base may vary to tailor the light pattern for different applications. Preferably the ratio of diameter of the corrugated sidewall at the ridge to diameter at bottom of the groove may be no less than 1.2 to further facilitate light interception in present LED lamps. The light pattern may become more uniform in space using LED lamp of the present invention.

In present invention, envelope may be substantially rigid or flexible. The size, shape, or slope of upper face and lower face may be also different. Optionally upper face may be tilted to a different extent from ridge than lower face. The direction and extent of tilt may vary along main axis of envelope. The size and shape of envelope may vary while achieving similar improvements in light pattern. For example, the ratio of diameter of corrugated sidewall at ridges to diameter of lamp base may vary preferably from 1 to 3; more preferably from 1 to 2. The outer skirt of envelope may be substantially globe-like. The ridges may be substantially sharp or dull. Sides of the envelope may be substantially linear, bent, or curved in a side view. Size and slope of the grooves and ridges may vary along main axis of lamp. Optionally envelope may further comprise a portion that is substantially transparent or an opening to facilitate light extraction of present LED lamps. The light pattern of present LED lamps may be favorably adjusted in many ways. For example, desirable beam shaping of present LED lamps may be achieved by changing slope of upper and lower faces; changing the number of grooves and ridges; incorporating a lower post or a concaved top portion, to name just a few. The light pattern may be also varied by changing LED layouts in the LED module.

In another general aspect, the present invention relates to an LED lamp comprising an envelope coupled to a lamp base, where the envelope may be foldable. For example, the envelope may be retracted or extended along its main axis by folding and unfolding of corrugated sidewall. Further, the envelope may be bendable simply by folding corrugated sidewall unevenly. It may be more extended at one side while more collapsed at the other. Thus the envelope may be further shaped to form a bent, a twist, a curve, an arm, or the like. Spatial light pattern thus may be further tuned simply by folding or bending of the envelope of present LED lamp.

Implementations of the system may include one or more of the following. In a simplified example, an LED lamp is fabricated using a lamp base that comprises one or more LEDs, and an envelope that comprises a corrugated sidewall. The envelope may be cost-effectively produced in volume using, for example, conventional extrusion and blow molding processes. The envelope may comprise, for example, a translucent plastic material such as nylon, polyester, polyethylene, PP (polypropylene), silicone; a plastic material filled with a light diffuser; or plastic materials filled with a phosphor. The periodicity of corrugations may vary along main axis of lamp. Top of envelope also comprises a translucent or semitransparent plastic material. The LED lamp is completed by coupling the envelope to an LED lamp base. The LED lamp base may be similar to and readily adapted, for example, from commercially available general purpose replacement LED lamp after removing its original envelope.

The present invention will be best described in detail with reference to the figures listed and is described below. These figures are intended solely for illustrative purposes.

### BRIEF DESCRIPTION OF THE DRAWINGS

FIG. 1 depicts a simplified, illustrative diagram of an exemplary LED lamp according to an embodiment of the present invention.

FIG. 1A depicts a simplified cross sectional view of an exemplary LED lamp envelope according to an embodiment of the present invention.

FIG. 2 depicts a graphical representation of spatial light distribution patterns of exemplary LED lamp A and bare lamp base.

FIG. 2A depicts a simplified, illustrative diagram of exemplary LED lamp A according to an embodiment of the present invention.

FIGS. 3A-3L depict simplified, illustrative diagrams of exemplary variations of LED lamps according to an embodiment of the present invention.

FIG. 4 depicts a graphical representation of spatial light distribution patterns of exemplary LED lamps A and B according to an embodiment of the present invention. The upper face of envelope in Lamp B is steeper in slope than lower face, opposite to that in lamp A.

FIG. 5 depicts a graphical representation of spatial light distribution patterns of exemplary LED lamps A and C according to an embodiment of the present invention. The envelope in LED lamp C comprises five periods of grooves and ridges instead of three as in lamp A.

FIG. 6 is a graph showing spatial light patterns of exemplary LED lamps A and D.

FIG. 6A is a simplified, illustrative diagram of exemplary LED lamp D according to another embodiment of the present invention.

FIG. 7 is a graph showing spatial light patterns of exemplary LED lamps A and E.

FIG. 7A is a simplified, illustrative diagram of exemplary LED lamp E according to another embodiment of the present invention.

FIG. 8 is a graph showing spatial light patterns of exemplary LED lamps A and P according to another embodiment of the present invention.

FIG. 8A is a simplified, illustrative diagram showing exemplary LED layout in LED lamp A.

FIG. 8B is a simplified, illustrative diagram showing exemplary LED layout in LED lamp P.

FIG. 9 is a graph showing spatial light patterns of exemplary LED lamps F and G according to another embodiment of the present invention. The light pattern of lamp C is included for comparison.

FIG. 9A depicts a simplified, illustrative diagram of exemplary LED lamp F. The envelope is folded down twice from the top.

FIG. 9B depicts a simplified, illustrative diagram of exemplary LED lamp G with envelope fully collapsed.

FIG. 10 is a graph showing spatial light patterns of exemplary LED lamp J according to another embodiment of the present invention. The light pattern of lamp C is included for comparison.

FIG. 10A is a simplified, illustrative diagram of exemplary LED lamp J.

### DETAILED DESCRIPTION OF THE INVENTION

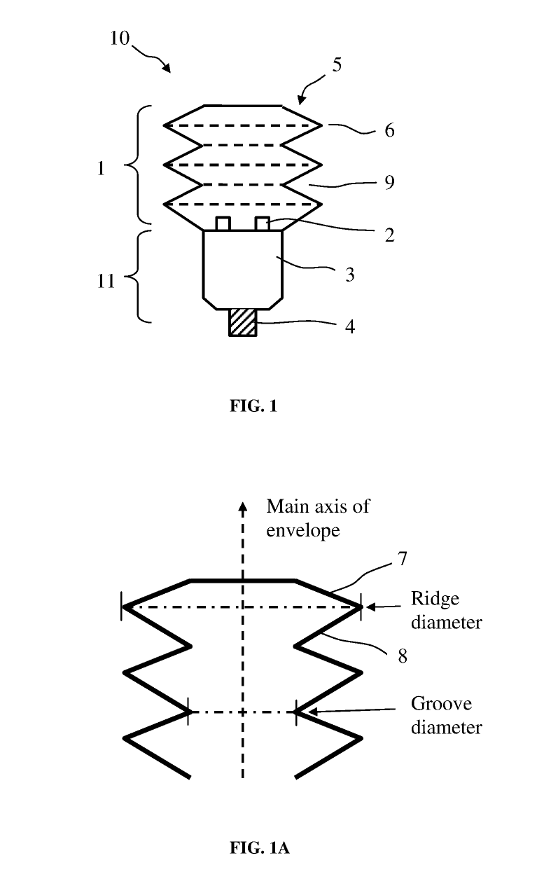

FIG. 1 is a simplified, illustrative diagram of an exemplary LED lamp according to an embodiment of the present invention. Lamp 10 comprises an envelope 1 coupled to a lamp base 11, which comprises an LED module, a driver circuitry, a housing 3, a socket cap 4. The driver circuitry is in electrical communication with an external power supply through socket cap 4. The LED module comprises one or more LEDs 2, which are substantially contained in an inner space defined by envelope 1 and lamp base 11. For the purpose of clarity, LED module and other components such as driver circuitry are not shown in diagram. In present invention, envelope 1 may comprise a translucent material that permits transmitting and diffusing of light. Light emission from LEDs 2 may be substantially refracted, reflected, or scattered by envelope 1. It may comprise a translucent plastic material such as, for example, polyester, polyethylene, polypropylene, silicone, nylon, or a plastic material filled with a light diffuser. The envelope may also comprise a plastic material filled with a light conversion material that absorbs a portion of LED emission and emits a light having a dominant peak wavelength different from that of the LED emission. For example, the light conversion material may be a phosphor such as garnet phosphor, silicate phosphor, nitride phosphor, sulfide phosphor, and combinations thereof.

In present LED lamps, envelope 1 may comprise a corrugated sidewall 5 formed of alternating ridges 6 and grooves 9. The grooves and ridges may comprise an upper face 7 and a lower face 8 as illustrated in FIG. 1A, which is a simplified, cross-sectional view of an exemplary envelope 1. The ridge diameter implies outer diameter of corrugated sidewall measured at the ridges. The groove diameter implies outer diameter of corrugated sidewall measured at the bottom of grooves. The grooves and ridges may be oriented substantially transverse to main axis of the envelope. The main axis of envelope 1 may be substantially in line with the main axis of LED lamp 10. Here main axis of LED lamp implies the center axis of LED lamp, which may be in line with the center axis of lamp base.

In present LED lamps, envelope 1 may be substantially tubular. A portion of light emission from LEDs 2 may be intercepted by corrugated sidewall 5 and exit envelope before reaching to the top. The intercepted light may be partially bent sideways through reflection, refraction, or scattering from corrugated side wall. The faces may be tilted to facilitate light interception. For example, upper face 7 may be slanted across LED light path for light interception. Lower face 8 may be oriented less obstructive to the path of light emission from LED. Since light emission from LED typically obeys a Lambertian distribution in free space, it may be partially intercepted by upper face 7 at certain entrance angles. By optimizing the geometry of corrugated sidewall 5, more light may be redirected and extracted out. The chance for light to emit sideways and to lower space is enhanced. The light pattern may become more uniform using the LED lamp of present invention. To further facilitate light interception of present LED lamps, the ratio of ridge diameter of corrugated sidewall 5 to groove diameter is preferably no less than 1.2.

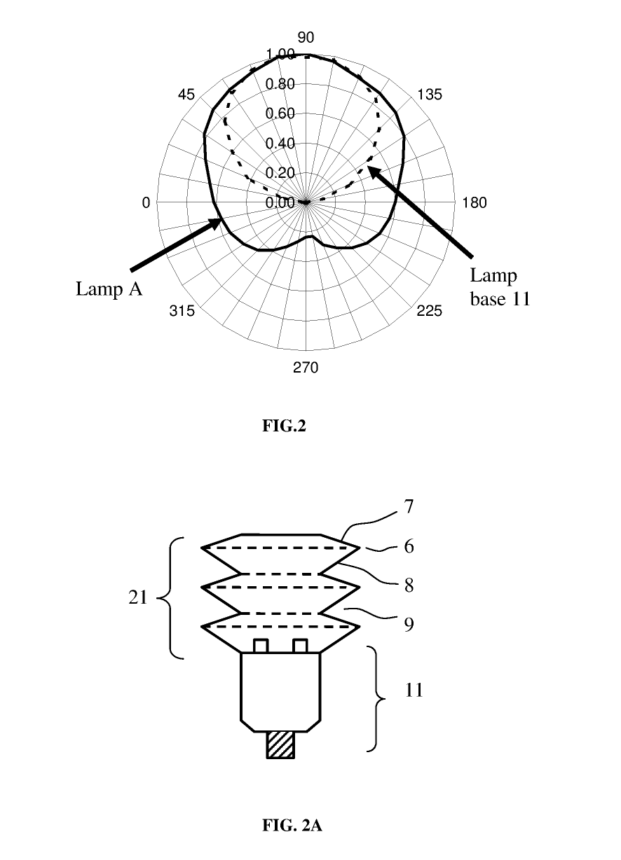

In present LED lamps, size, shape, and slopes of upper face 7 and lower face 8 may be same or different. Optionally upper face 7 may tilt to a different extent from peak 6 than lower face 8. FIG. 2A is a. simplified, illustrative diagram of exemplary LED lamp A. In LED lamp A, lower face 8 is steeper in slope than upper face 7. Optionally the direction and extent of tilt may vary along main axis of envelope 1 to optimize light interception and light extraction. Further, the size of envelope 1 may vary to tailor the light pattern for desirable applications. For example, the ratio of ridge diameter of corrugated sidewall 5 to diameter of lamp base 11 may vary from 1 to 3; preferably from 1 to 2.

The fabrication of present LED lamps is described. An exemplar LED lamp A is fabricated using a lamp base 11 and an envelope 21. Envelope 21 is substantially tubular comprising three periods of grooves and ridges. In this example, envelope 21 is made of a polypropylene plastic material. It appears translucent to naked eyes and transmits about 65% of white light. It is approximately 48 mm in height. The diameter is about 35 mm at the bottom of the grooves and about 54 mm at the ridges. The corrugated sidewall is about 0.5 mm or less in thickness. The envelope may be produced cost-effectively in volume using conventional extrusion and blow molding processes, similar to that for extensible corrugated plastic tubing. The shape of envelope is defined by the surface contour of molds in blow molding machine. Top of envelope 21 may also comprise a translucent plastic material. In this example, upper face and lower face are tilted to different extent. The lower face 8 is about 13 mm in width and tilted about 45 degree from ridge 6. The upper face 7 is about 11 mm in width and tilted about 30 degree from ridge 6. The ratio of ridge diameter of corrugated sidewall to groove diameter is about 1.5. The periodicity of grooves and ridges is about 15 mm along main axis of envelope 21. Lamp A is completed by coupling envelope 21 to an LED lamp base 11. The lamp base may be a conventional replacement bulb after removing its original envelope. In one example, it is readily adapted from a GE 60 W general purpose (GP) replacement bulb. The LED module comprises six LEDs mounted on a PCB board. The PCB board may be a metal core PCB board (MCPCB) attached to the top of lamp base 11 using a thermal conductive paste. The LEDs are spaced apart and deployed near midway from center axis of lamp base 11 in a top view. The GE lamp is advertised to emit 760 lumens under 10 W power consumption. It bears a part number of 79369 (UPC 043168793698). The diameter of lamp base 11 is about 1.5 inches. The ratio of ridge diameter of corrugated sidewall to diameter of lamp base 11 is about 1.4.

The brightness of lamp A is measured using a conventional digital lux meter. It provides a measure of amount of “usable” light created by LED lamp on a lighted surface. The brightness reading is recorded at 11.25 degree interval over a 9-inch radius circle in a vertical plane containing main axis of lamp A. LED lamp A is situated at about center of the circle. The zero degree horizontal is approximately aligned with top of lamp base 11, while main axis of LED lamp is pointing at the 90 degree north. Light pattern is plotted as angular distribution of relative brightness after normalizing the brightness against its maximum value. The far-field light pattern thus obtained serves as a first indication of the effectiveness in beam shaping using LED lamps in present invention.

FIG. 2 shows spatial light patterns of exemplary lamp A and bare lamp base 11. In this chart, relative brightness is plotted from 0 to 1 at an interval of 0.2. The upper half of the chart (0-180 degree clockwise) implies light emission into upper space above top surface of lamp base 11. The lower half of the chart (180-360 degree clockwise) implies light emission into lower space below top of lamp base 11. The dip in brightness near 270 degree direction is due to light blocking by lamp base 11. The solid line represents light pattern of lamp A. The dotted line in FIG. 2 represents light pattern of bare lamp base 11 without an envelope in place. The bare lamp base 11 substantially emits into upper half of the free space, approximating that of a Lambertian distribution in light pattern. In lamp A, sideway light emission is significantly increased and the light pattern appears more uniform. About 30% of useful light of LED lamp emits into a lower space approximately below surface of lamp base. The brightness at 135 degree angle from north of lamp main axis is about 60% of the average brightness in a 135-degree zone from north of lamp main axis.

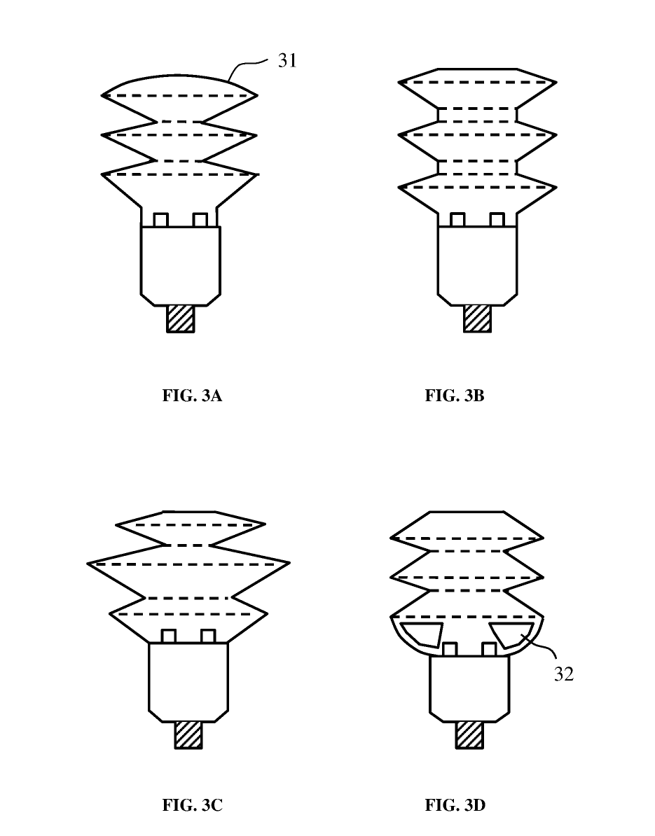

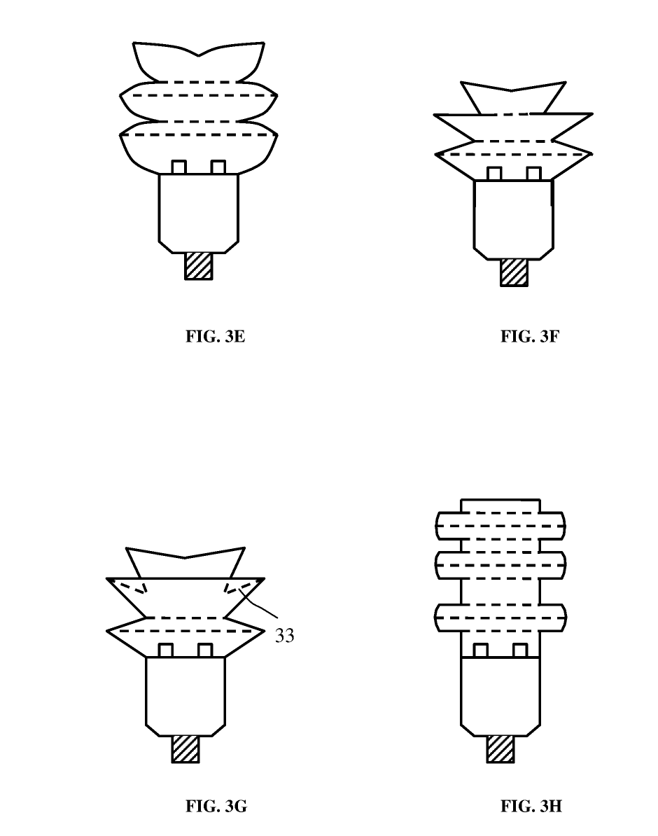

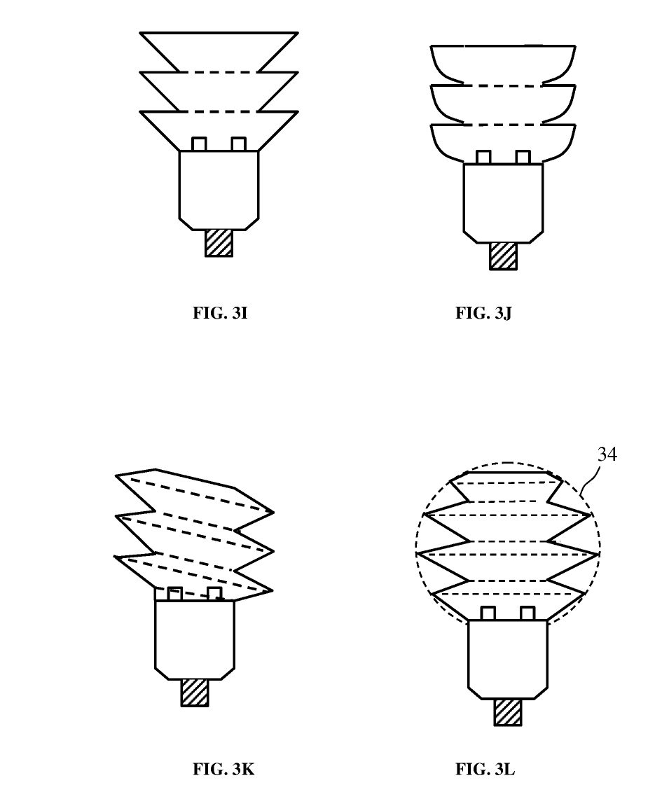

In present LED lamps, envelope 1 may vary in shape while achieving similar improvements in light pattern. For example, the sides of envelope 1 may be substantially linear, bent, curved, or combinations thereof when viewed from side. Ridges 6 may be substantially sharp or dull in side view. FIGS. 3A-3L are simplified, illustrative diagrams of exemplary LED lamps in present invention. Top surface 31 of envelope may be bent or curved in a side view The diameter at bottom of the grooves may be smaller than that of the lamp base as illustrated in FIG. 3A. The bottom of grooves may comprise a flat portion as shown in FIG. 3B. Size and slope of the faces may vary along main axis of lamp as shown in FIG. 3C. Envelope 1 may further comprise a portion that is substantially transparent to facilitate light extraction of present LED lamps. For example, a lower bottom of envelope may comprise a transparent plastic material, or an opening 32 as shown in FIG. 3D. When lower face 8 are substantially transparent or comprise an opening, the corrugated portion may resemble that of shingles or louvers. Optionally lower face 8 may compose a material that transmits more light than upper face 7. It may be readily fabricated, for example, using a lesser amount of light diffuser in lower face 7 or simply by using a thinner wall section so more light may pass through it. Optionally the faces may be tilted towards different directions along the main axis of envelope 1 as shown in FIG. 3F. Further, upper face 33 may be concaved in shape as shown in FIG. 3G. Optionally upper face or lower face may be substantially leveled in a side view. Further, ridge 6 may be substantially curved or linear in a side view like a spacer between upper and lower faces as illustrated in FIG. 3H. The upper and/or lower faces may be substantially linear, bent, curved, or combinations thereof when viewed from the side as shown in FIG. 3E, FIG. 3I and FIG. 3J. The corrugated portion may be substantially slanted or twisted about main axis of envelope 1 as shown in FIG. 3K. The outer skirt 34 of envelope may be substantially globe-like as shown in FIG. 3L. For example, it may resemble the general shape of an A19 lamp or a general purpose (GP) lamp. The envelope may vary in shape when viewed from the top. Preferably envelope 1 may be substantially rounded, polygonal, or combinations thereof in a top view.

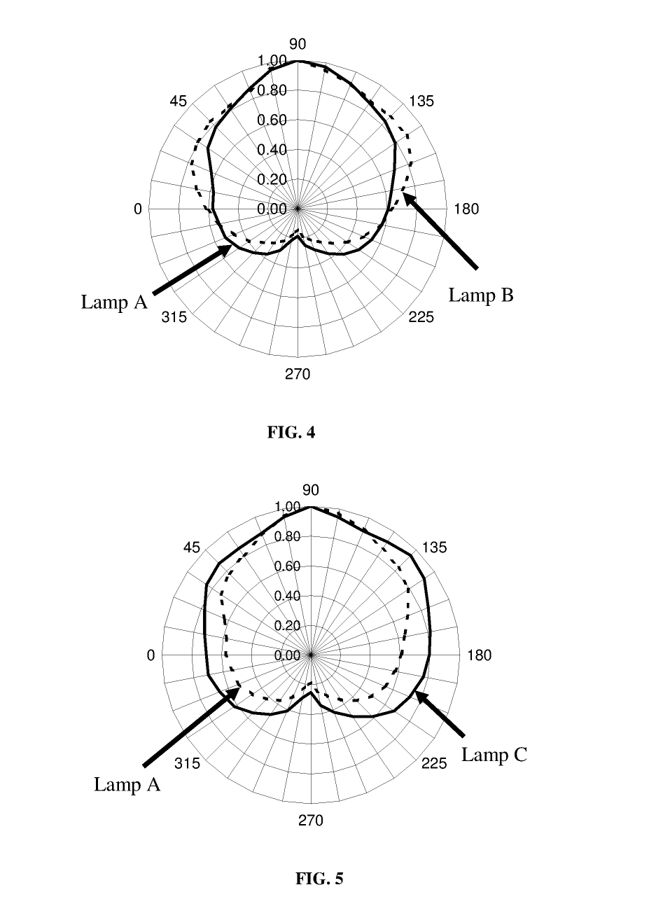

In present LED lamps, light pattern may be further varied by adjusting tilt angle of upper and lower faces. Lamp B is fabricated in a similar way except that in this case the upper faces become steeper in slope than lower faces, opposite of that in lamp A. In lamp B, lower face is tilted about 30 degree downwards from ridge 6, while upper face is tilted about 45 degree upwards from ridge 6. FIG. 4 shows spatial light pattern of exemplary LED lamps A and B. It is clear seen that more light emits into lower space using lamp A than lamp B. The light pattern of present LED lamp may be further improved by optimizing slopes of upper face 7 and lower face 8.

By increasing the number of grooves and ridges in corrugated sidewall 5, there is more chance for light to be intercepted and extracted out. Lamp C is fabricated in a similar way as Lamp A using lamp base 11 and an envelope resembling envelope 21 but comprising five periods of grooves and ridges.

FIG. 5 shows spatial light pattern of exemplary LED lamp C. The light pattern of lamp A, which contains three periods of grooves and ridges is included for comparison. It is clearly seen that more light is redirected and extracted out sideways using lamp C. The light pattern appears more uniform and about 35% of useful light of LED lamp emits into a lower space approximately below surface of lamp base. The brightness at 135 degree angle from north of lamp main axis is about 70% of the average brightness in a 135-degree zone from north of lamp main axis. The improvement in light pattern appears more pronounced when corrugated portion of envelope comprises more grooves and ridges.

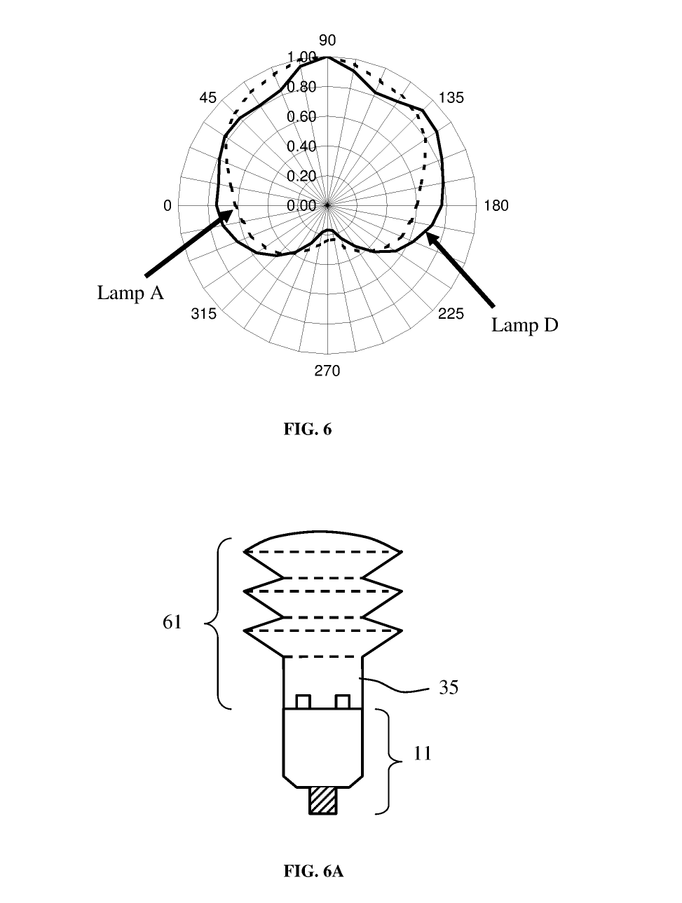

In another preferred embodiment of the present invention, envelope 1 may further comprise a lower post in present LED lamps. Lamp D is fabricated in a similar way using lamp base 11 and envelope 61. The corrugated portion of envelope 61 is raised from lamp base 11 by a lower post 35 that is coupled to lamp base 11. FIG. 6A is a simplified, illustrative diagram of exemplary LED lamp D. The corrugated sidewall of envelope 61 comprises three periods of grooves and ridges. The lower post is about 19 mm in height and transmits about 74% of white light through its tubular wall. FIG. 6 shows spatial light pattern of exemplary LED lamps A and D. Compared with lamp A, more light emits sideways in lamp D. Since light emission from LED typically exhibits a Lambertian distribution, e.g., the dotted line in FIG. 2, light tends to travel towards the top. By raising the corrugated portion of envelope, light interception may become more efficient. Optionally lower post 35 may be substantially linear, bent, or curved in shape in a side view. The light pattern also suggests some light piping towards top due to presence of lower post.

In another preferred embodiment of the present invention, envelope 1 may further comprise a concaved top portion in present LED lamp. The shape of concaved top portion may vary. For example, it may resemble the general shape of a cup, dish, cone, or the like. It may be substantially linear, bent, curved, or combinations thereof in a side view. Lamp E is fabricated in a similar way using lamp base 11 and envelope 71, which comprises three periods of grooves and ridges and a dish-shaped concaved top portion 36.

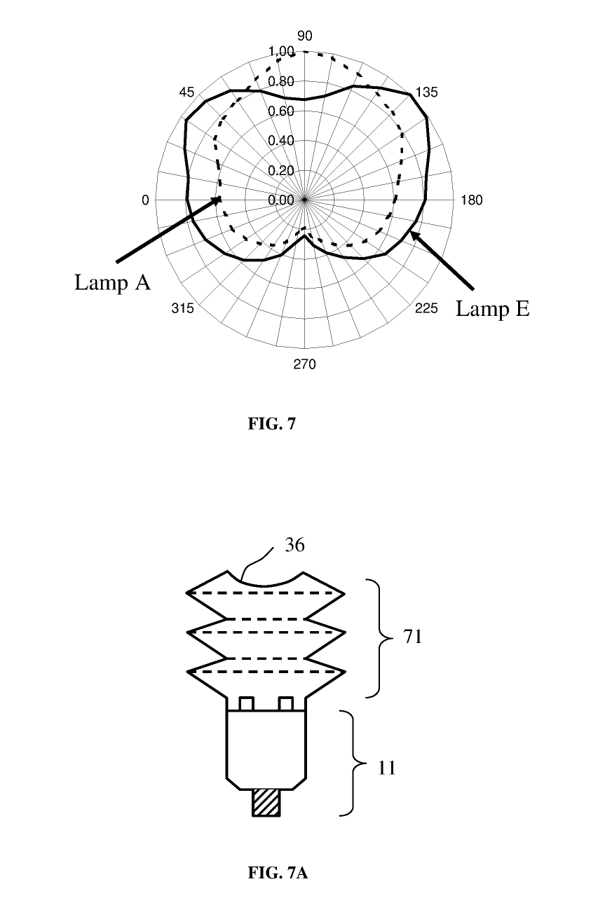

FIG. 7A is a simplified, illustrative diagram of exemplary LED lamp E. In this example, concaved top portion 36 is about 38 mm in diameter and 10 mm in depth at center of dish. It appears translucent to the naked eye and transmits about 74% of white light.

FIG. 7 shows spatial light pattern of exemplary LED lamps A and E. Compared with lamp A, more light emits sideways and into lower space in lamp E. In lamp E, a portion of light emission reaching the top may be redirected towards corrugated sidewall of envelope through reflection, refraction, or scattering from concaved top portion 36. About 36% of useful light of LED lamp emits into a lower space approximately below surface of lamp base. The brightness at 135 degree angle from north of lamp main axis is about 70% of the average brightness in a 135-degree zone from north of lamp main axis. By further optimizing the geometry of envelope, light pattern of present LED lamps may become more uniform or substantially omnidirectional.

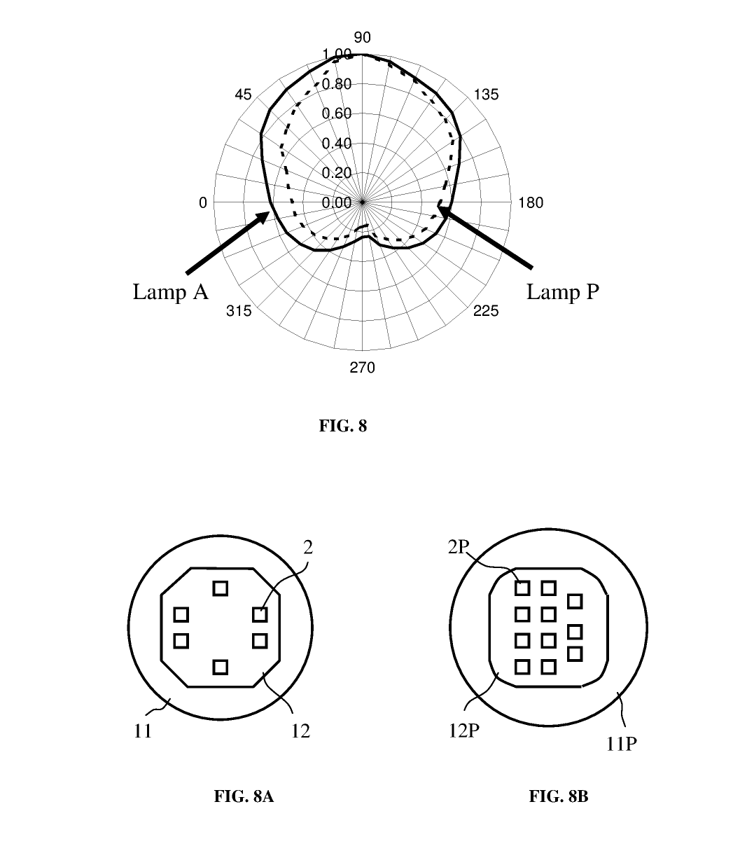

The light pattern may be further varied by changing the layout of LED in LED module, which is coupled to top surface of lamp base. For example, the LEDs may be conveniently deployed across LED module, clustered near center of LED module, or away from center of LED module. Lamp A comprises envelope 21 and lamp base 11. There are six LEDs 2 spaced apart from each other in LED module 12. The LEDs are deployed at about midway from center of lamp base 11 in a top view. This is illustrated in FIG. 8A, which is a simplified, illustrative diagram of LED layout in lamp base 11. In comparison, lamp P is fabricated similarly using envelope 21 and lamp base 11P, which comprises an array of eleven LEDs 2P that are substantially clustered about center of LED module 12P.

FIG. 8B is simplified, illustrative diagram of LED layout in lamp base 11P. In this example, lamp base 11P may be similar to that of conventional 60 W replacement A19 or general purpose (GP) LED light bulbs after removing their original envelope. For example, it may be readily adapted from a Philips 60 W general purpose (GP) replacement bulb (model 9290011350, UPC 046677455552). The Philips bulb is advertised to emit 800 lumens at a power consumption of 8.5 W.

FIG. 8 shows spatial light pattern of exemplary LED lamps A and P in present invention. The light pattern appears more uniform when using lamp A. Since the LEDs are located in closer proximity to corrugated sidewall of envelope in lamp A, more light may be collected and exit envelope. In lamp P, light emission from center of LED cluster may elude interception and find its way to the top. The results suggest that improvement in light pattern is more pronounced using light sources where LEDs are deployed away from center of LED module.

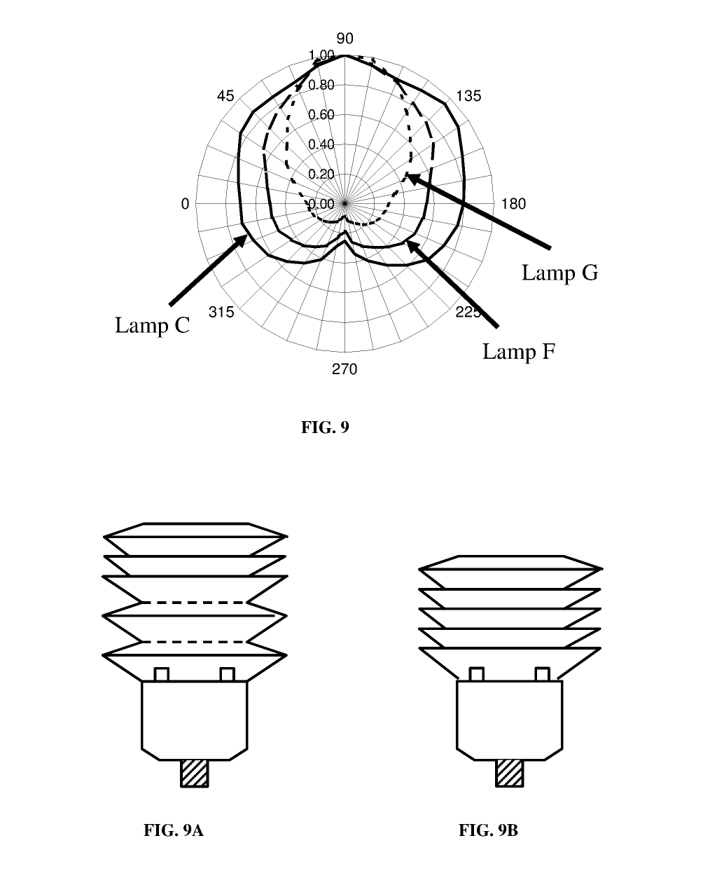

In present LED lamps, envelope 1 may be substantially flexible. In another preferred embodiment of the present invention, envelope 1 in present LED lamps may be foldable. For example, envelope 1 may be retracted or extended about its main axis by folding and unfolding of corrugated sidewall. Thus ridges 6 and grooves 9 in corrugated portion of envelope 1 may function as hinges. The upper and lower faces may be different in size to facilitate easy folding and unfolding of corrugated sidewall. The overall height of envelope may thus become adjustable. By simply extending or retracting the corrugated sidewall, light pattern of present LED lamps may also become tunable. As described above, Lamp C is fabricated using lamp base 11 and an envelope comprising five periods of grooves and ridges similar to that shown in FIG. 9A but fully extended upright. Lamp F and lamp G are fabricated similarly as lamp C, also comprising five periods of grooves and ridges. In lamp F, however, the corrugated sidewall is folded down twice from the top as shown in FIG. 9A. The corrugated sidewall is fully collapsed in lamp G as shown in FIG. 9B.

FIG. 9 shows spatial light pattern of exemplary LED lamps F and G. The light pattern of lamp C is also included for comparison. It is clearly seen that by sequential folding of corrugated portion from top down, light pattern changes from more uniform to more directional. It suggests that side emission decreases as the corrugated sidewall collapses. The results are similar whether grooves 5 and ridges 6 are collapsing from top down, bottom up, or anywhere in-between. The present LED lamps thus enable quick and easy tuning of spatial light pattern simply by extension or retraction of the envelope.

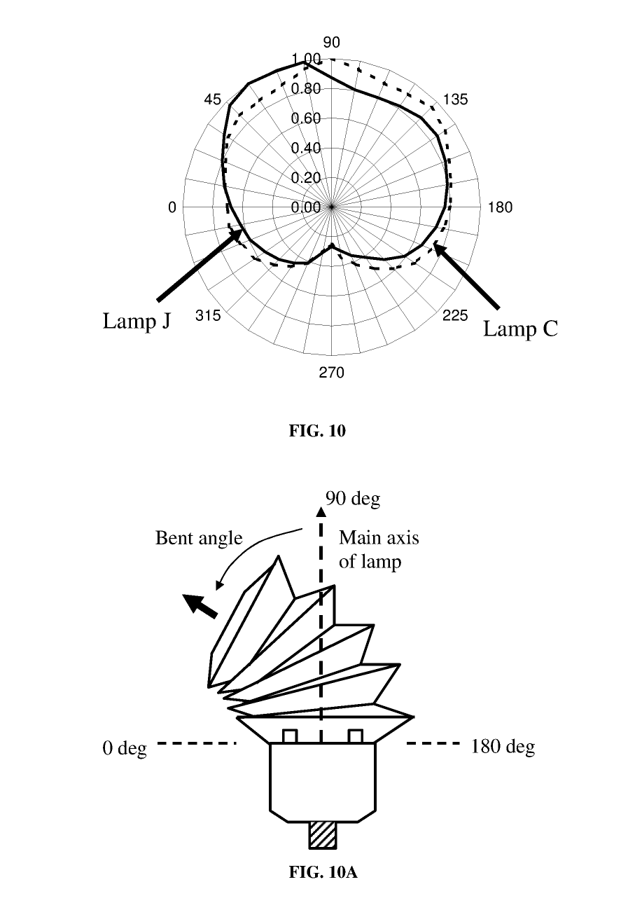

In another preferred embodiment of the present invention, envelope 1 of present LED lamps may be bendable. For example, it may be bent simply by folding corrugated sidewall unevenly. Thus envelope 1 may be shaped to form a bent, a twist, a curve, an arm-like shape or the like. The corrugated portion may be more extended at one side while more collapsed at the other. The envelope may be turning away from the north of main axis of lamp by a bent angle. As described above, Lamp C is fabricated using lamp base 11 and an envelope comprising five periods of grooves and ridges similar to that shown in FIG. 9A but fully extended upright. The main axis of envelope is substantially in line with main axis of lamp. Lamp J is fabricated similarly as lamp C, except that the grooves and ridges are fully extended at one side while fully collapsed at other side. FIG. 10A is a simplified, illustrative diagram of exemplary LED lamp J. In this example, the envelope curves away from main axis of lamp pointing at a direction about 50 degrees from north of the main axis of LED lamp.

FIG. 10 shows spatial light pattern of exemplary LED lamps C and J. Compared with Lamp C where corrugated sidewall is fully extended upright, the light pattern of lamp J appears uneven with the peak brightness skewed towards one side. It suggests that light interception is more effective at the side where corrugated sidewall is more extended, while less light may be redirected at the other side where corrugated sidewall is more collapsed. The spatial light pattern of present LED lamps thus may be further tuned simply by bending of the envelope in a desirable fashion. This represents another benefit using the LED lamps of present invention.

There are additional benefits using present LED lamps over conventional LED lamps. For example, the presence of corrugated sidewall implies an increase in effective surface area of envelope that may facilitate randomization of light emission from LED through light reflection, refraction, and scattering. In conventional LED lamps, light emission may be trapped due to wave guiding, e.g., by whispering gallery mode, inside envelope. The wave guiding may be disrupted by corrugated portion in present LED lamps. As a result, the optical loss due to light trapping may be reduced and more light may be extracted out. To those skilled in the art, it is apparent that there may be alterations and modifications either implied from or suggested by the teaching in the description and in the drawings of the present invention. Accordingly, the present invention is to be limited solely by the scope of the following claims.

1-21. (canceled)

22. An LED lamp comprising an envelope and a lamp base; wherein
said envelope is substantially coupled to said lamp base;
said lamp base comprises an LED module, a driver circuitry, a housing, and a socket cap;
said LED module comprises one or more LEDs;
said envelope and said lamp base substantially define an inner space;
said LEDs are substantially contained in said inner space;
said envelope comprises a corrugated sidewall formed of alternating ridges and grooves;
said ridges and grooves are substantially oriented transverse to a main axis of said envelope;
said envelope is substantially translucent.

23. The LED lamp in claim 22, wherein said envelope is substantially rounded, polygonal, or combinations thereof in shape in a top view.

24. The LED lamp in claim 23, wherein a ratio of ridge diameter to groove diameter of said corrugated sidewall is preferably no less than 1.2.

25. The LED lamp in claim 23, wherein said lamp base is substantially rounded in shape in a top view; wherein a ratio of ridge diameter of said corrugated sidewall to a diameter of said lamp base is preferably in a range from 1 to 3; more preferably from 1 to 2.

26. The LED lamp in claim 22, wherein said envelope is substantially tubular.

27. The LED lamp in claim 22, wherein an outer skirt of said envelope is substantially globe-like.

28. The LED lamp in claim 22, wherein said envelope is substantially flexible.

29. The LED lamp in claim 22, wherein said envelope further comprises a portion that is substantially transparent or an opening.

30. The LED lamp in claim 22, wherein said alternating ridges and grooves further comprise an upper face and a lower face; said upper face and said lower face are different in size, shape, slope, or combinations thereof.

31. The LED lamp in claim 22, wherein a top portion of said envelope is substantially linear, bent, curved, or combinations thereof in a side view.

32. The LED lamp in claim 22, wherein said envelope further comprises a concaved top portion.

33. The LED lamp in claim 22, wherein said envelope further comprises a lower post;
wherein said lower post is coupled to said lamp base; and,
wherein said corrugated sidewall is raised from said lamp base by said lower post.

34. The LED lamp in claim 22, wherein said envelope is foldable.

35. The LED lamp in claim 22, wherein said envelope is bendable.

36. The LED lamp in claim 22, wherein said envelope is adjustable in shape.

37. The LED lamp in claim 22, wherein a spatial light pattern of said LED lamp is tunable by folding of said envelope.

38. The LED lamp in claim 22, wherein a spatial light pattern of said LED lamp is tunable by bending of said envelope.

39. The LED lamp in claim 22, wherein said envelope having at least one of a group consisting of a translucent plastic material, a plastic material filled with a light diffuser and a plastic material filled with a light conversion material.

40. The LED lamp in claim 22, wherein said one or more LEDs are deployed away from a center of said LED module.
